(19) United States
(12) Patent Application Publication
(10) Pub. No.: US 2010/0169555 A1
(43) Pub. Date: Jul. 1, 2010

(54) METHOD OF WRITING DATA INTO FLASH MEMORY BASED ON FILE SYSTEM

(75) Inventors: Chien-Ping Chung, Taipei (TW); Chia-Hsin Chen, Taipei (TW); Ming-Che Liu, Taipei (TW)

Correspondence Address: KIRTON AND MCCONKIE, 60 EAST SOUTH TEMPLE,, SUITE 1800, SALT LAKE CITY, UT, 84111, US

(73) Assignee: ASMEDIA TECHNOLOGY INC., Taipei (TW)

(21) Appl. No.: 12/632,668

(22) Filed: Dec. 7, 2009

(30) Foreign Application Priority Data
Dec. 26, 2008 (TW) 097151077

(51) Int. Cl. G06F 12/02; G06F 12/00

(52) U.S. Cl. 711/103; 711/E12.001; 711/E12.008

(57) ABSTRACT

A method of writing data into flash memory based on OS file system is provided. The method includes steps of: obtaining a data start position of a data area in a first partition of a flash memory; converting the data start position into a first block number and a first page number; calculating an offset and adding the offset to the first page number to be an updated first page number when the first page number is not an integer; and, setting the first block number and the updated first page number as a new data start position of the data area and writing a first data according to the new data start position.

### FIELD OF THE INVENTION

The present invention relates to a method of writing data into a flash memory, and more particularly, to a method of writing data into the flash memory based on file system.

### BACKGROUND OF THE INVENTION

It is well-known that a flash memory has advantages of anti-shock, non-volatile, and with high storage density. Hence, a flash memory storage device formed by allocating the flash memory with its control circuit has been widely used, such as: a thumb drive, a compact flash memory card (CF), a secure digital memory card (SD), a multi media card (MMC), and so on.

As is known to all, the data space of the flash memory is composed of a plurality of blocks, wherein each block consists of a plurality of pages. In addition, the basic unit for accessing the flash memory is one page, but the basic unit for erasing the flash memory is one block. That is to say, the flash memory has characteristics of “Block Erase” and “Page Program”. What calls for special attention is that the flash memory must write data from a low page number to a high page number sequentially.

Moreover, the file system used in current operating system (OS) of computers usually adopts characteristics of hard disks as its accessing manner. Currently the most common file system types include a file allocation table 12 file system (FAT 12), a file allocation table 16 file system (FAT 16), a file allocation table 32 file system (FAT 32), a new technology file system (NTFS), a second extended file system (EXT 2), or a third extended file system (EXT 3). In general, the FAT 12/16/32 and NTFS are applied to Windows operating system, while the EXT 2 and the EXT 3 are applied to Linux operating system.

As an illustration, please refer to FIG. 1A. FIG. 1A is a diagram illustrating how a conventional operating system of a computer sets partitions upon a hard disk according to prior art. First, the operating system (OS) builds a master boot record (MBR) at a Sector 0 of the hard disk according to the user's settings. The MBR has a size equaling M sectors, and it includes a disk primary partition table. The information recorded in the disk primary partition table is listed as below: (1) a total number of partitions included in the hard disk; (2) a file system type and a size of each partition; (3) a partition start position corresponding to each partition; and (4) a number of sector units for each partition managed by the operating system; wherein each sector is defined as 512 bytes.

Assume that the user performs a partitioning upon the hard disk by means of a disk partition program (such as FDISK), such that the hard disk is divided into a Partition C and a Partition D. Herein, a file system type of the Partition C is FAT 32, and a file system type of the Partition D is NTFS. Hence, the disk primary partition table of the MBR records that: (1) this hard disk totally consists of two partitions; (2) the first partition has a file system type of FAT 32 and has a size equaling “A sectors”, and the second partition has a file system type of NTFS and has a size equaling “B sectors”; (3) the partition start position corresponding to the first partition is located at “Sector a”, and the partition start position corresponding to the second partition is located at “Sector b”; and (4) the sector units for FAT 32 managed by the operating system is 16K bytes (i.e., 32 sectors), and the sector units for NTFS managed by the operating system is 4K bytes (i.e., 8 sectors).

Moreover, after both of the two partitions are formatted, each of the two partitions respectively builds up a management table. The first management table of the first partition is called as FAT table, which is begun from the “Sector a” of the first partition and has a size equaling “E sectors”. The second management table of the second partition is called as NTFS table, which is begun from the “Sector b” of the second partition and has a size equaling “F sectors”.

From FIG. 1A, we can see that the actual data start position of the data area in the first partition should be “Sector e”, wherein “Sector e”=“Sector (a+E)”; and the actual data start position of the data area in the second partition should be “Sector f”, wherein “Sector f”=“Sector (b+F)”. In addition, owing to the sector units for FAT 32 managed by the operating system is 16K bytes (i.e., 32 sectors), the data areas in the first partition are divided into a plurality of data sub-areas in units of 16K bytes, wherein the plurality of data sub-areas are managed by the FAT table. Similarly, owing to the sector units for NTFS managed by the operating system is 4K bytes (i.e., 8 sectors), the data areas in the second partition are divided into a plurality of data sub-areas in units of 4K bytes, wherein the plurality of data sub-areas are managed by the NTFS table.

Furthermore, as can be known from FIG. 1A, the start sectors corresponding to the plurality of data sub-areas in the first partition are sequentially “Sector e”, “Sector (e+32)”, “Sector (e+64)”, “Sector (e+96)”, . . . and so on. The start sectors corresponding to the plurality of data sub-areas in the second partition are sequentially “Sector f”, “Sector (f+8)”, “Sector (f+16)”, “Sector (f+24)”, . . . and so on. Additionally, when the host issues a read/write command, its writing position must begin from the start sector of the corresponding data sub-area.

As an illustration, please refer to FIG. 1B. FIG. 1B is a diagram illustrating how a host writes data into the hard disk. When the host writes a first file 100 having a file size of 8K bytes into the data area of the first partition, this first file 100 can be written into any data sub-area but its writing position must begin from the start sector of the corresponding data sub-area (for example, the “Sector (e+32)”. From FIG. 1B, we can see that the writing position of the first file 100 begins from the “Sector (e+32)”. After the writing of the first file 100 is completed, the remainder capacity of this data sub-area will no longer be able to write other data.

In a similar way, when the host writes a second file 200 having a file size of 7K bytes into the data area of the second partition, this second file 200 can be written into any data sub-area but its writing position must begin from the start sector of the corresponding data sub-area. From FIG. 1B, we can see that the writing position of the second file 200 begins from the “Sector (f+8)” and the second file 200 occupies two data sub-areas. Herein the first data sub-area has no remainder capacity, while the next data sub-area has remainder capacity. Similarly, this remainder capacity included in the next data sub-area will no longer be able to write other data.

From what has been mentioned above, we may know the writing method that how the host writes data into the hard disk. However, when the hard disk is replaced by the flash memory, the writing efficiency of the flash memory will be lowered due to the flash memory having characteristics of “Block Erase” and “Page Program” if the abovementioned writing method is directly applied to the flash memory.

### SUMMARY OF THE INVENTION

It is therefore one of the objectives of the present invention to provide a method of writing data into a flash memory based on file system.

According to an exemplary embodiment of the present invention, a method of writing data into a flash memory based on file system is provided. The method includes the following steps: obtaining a data start position of a data area in a first partition of the flash memory; converting the data start position into a first block number and a first page number; when the first page number is not an integer, calculating an offset and adding the offset to the first page number to be an updated first page number; and setting the first block number and the updated first page number as a new data start position of the data area, and writing a first data into the flash memory according to the new data start position.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a diagram illustrating how a conventional operating system of computers sets partitions upon a hard disk according to prior art;

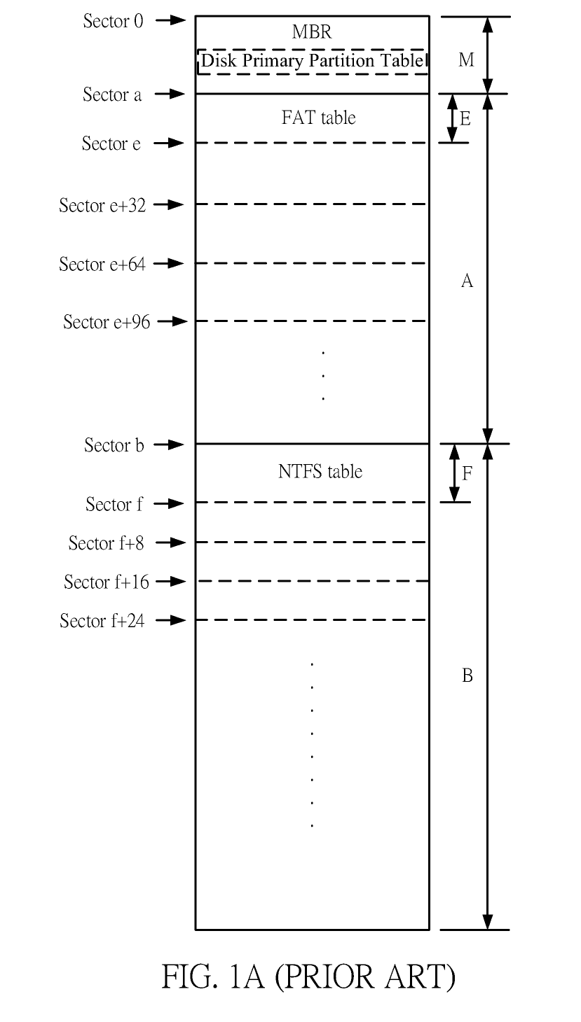

FIG. 1B is a diagram illustrating how a host writes data into the hard disk;

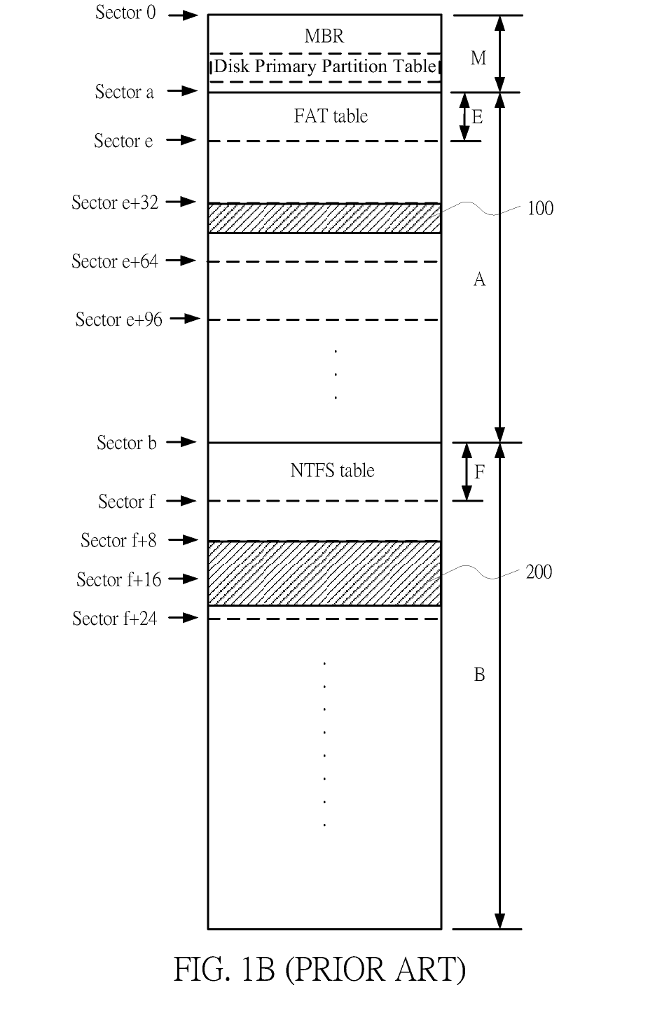

FIG. 2 is a diagram illustrating partitions of a flash memory;

FIG. 3 is a flowchart illustrating a method of writing data into a flash memory based on file system according to an exemplary embodiment of the present invention;

FIG. 4 is a diagram illustrating data areas and data sub-areas of a flash memory; and

FIG. 5 is a diagram illustrating how a host writes data into the flash memory.

### DETAILED DESCRIPTION OF THE PREFERRED EMBODIMENT

As is known to all, the flash memory has characteristics of “Block Erase” and “Page Program”. The flash memory must write data from a low page number to a high page number sequentially. A flash translation layer (FTL) of the flash memory is capable of adjusting a write command and a program data issued by a host, and writing data into the flash memory with a basic unit of one page. The FTL is disposed inside the flash memory, and it can be implemented by a flash controller.

Assume that a block of a flash memory consists of eight pages (e.g. Page 0˜Page7), and each page has a size of 4K bytes. As a result, the position taking sectors as the basic unit issued by the host is first converted into another position taking blocks and pages as the basic unit to be written by the FTL. That is to say, when the FTL receives the “Sector x”, the numeral “x” is divided by 64 so as to obtain a first quotient and a first remainder, wherein the first quotient is used as the block number and the first remainder is divided by 8 to obtain a second quotient used as the page number. For example, when the numeral “x” is equal to 273, the first quotient of 273/64 is equal to 4 and the first remainder is equal to 17. In addition, the second quotient of 17/8 is equal to 2 (17/8=2+1/8). In other words, the position of the “Sector 273” can be converted into the position expressed by 1/8 of Page 2 of Block 4 in the flash memory. That is, all the positions expressed by sectors issued from the host will be converted into the corresponding positions expressed by blocks and pages.

In other words, when the user performs a partitioning upon the flash memory by means of a disk partition program (such as FDISK) under the operating system, all the positions expressed by sectors are converted into the corresponding positions expressed by blocks and pages via the FTL. After the whole flash memory has been formatted, there are a MBR and management tables of each partition built in the whole flash memory as well.

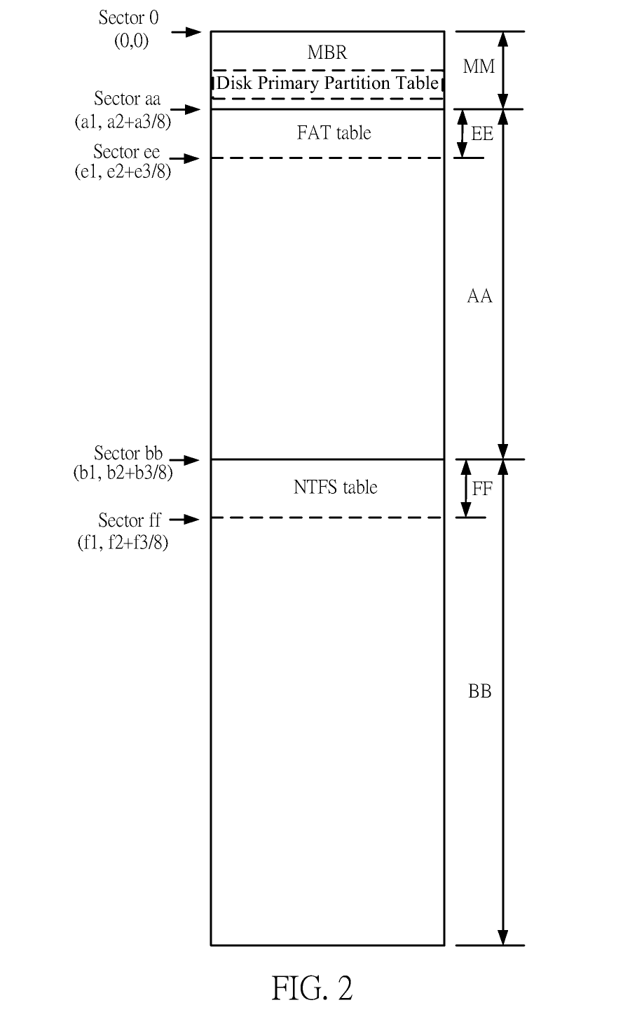

As an illustration, please refer to FIG. 2. FIG. 2 is a diagram illustrating partitions of a flash memory. Assume that the user performs a partitioning upon the flash memory by means of a disk partition program (such as FDISK), such that the flash memory is divided into two partitions. The first partition has a file system type of FAT32 and has a size equaling “AA sectors”, and the second partition has a file system type of NTFS and has a size equaling “BB sectors”. Moreover, the partition start position corresponding to the first partition is located at “Sector aa”, and the partition start position corresponding to the second partition is located at “Sector bb”. In addition, the sector units for FAT32 managed by the operating system is 16K bytes (i.e., 32 sectors), and the sector units for NTFS manages by the operating system is 4K bytes (i.e., 8 sectors). The abovementioned information will be recorded in the MBR, wherein the MBR has a size equaling “MM sectors”.

In a similar way, after both of the two partitions are formatted, each of the two partitions respectively builds up a management table. The first management table of the first partition is called as FAT table, which is begun from the “Sector aa” of the first partition and has a size equaling “EE sectors”. The second management table of the second partition is called as NTFS table, which is begun from the “Sector bb” of the second partition and has a size equaling “FF sectors”. Herein the size of the management table is related to its file system type, and is defined by its file system specification respectively. By reference to the specification, the actual size of the management table (e.g., “EE sectors” or “FF sectors”) can be calculated.

From FIG. 2, we can see that the actual data start position of the data area in the first partition should be “Sector ee”, wherein “Sector ee”=“Sector (aa+EE)”; and the actual data start position of the data area in the second partition should be “Sector ff”, wherein “Sector ff”=“Sector (bb+FF)”. All of the abovementioned positions can be converted into a block number and a page number. That is to say, the “Sector 0” can be converted into Page 0 of Block 0 (0, 0); the “Sector aa” can be converted into the position expressed by a3/8 of Page a2 of Block a1 (a1, a2+a3/8); the “Sector ee” can be converted into the position expressed by e3/8 of Page e2 of Block e1 (e1, e2+e3/8); the “Sector bb” can be converted into the position expressed by b3/8 of Page b2 of Block b1 (b1, b2+b3/8); and the “Sector ff” can be converted into the position expressed by f3/8 of Page f2 of Block f1 (f1, f2+f3/8).

According to an embodiment of the present invention, after the flash memory has been formatted by the user, the FTL will detect the data start position of the corresponding data areas in each partition before writing data into the flash memory. If the data start position is not aligned with one page, add an offset to the data start position such that the updated data start position can be aligned with one page.

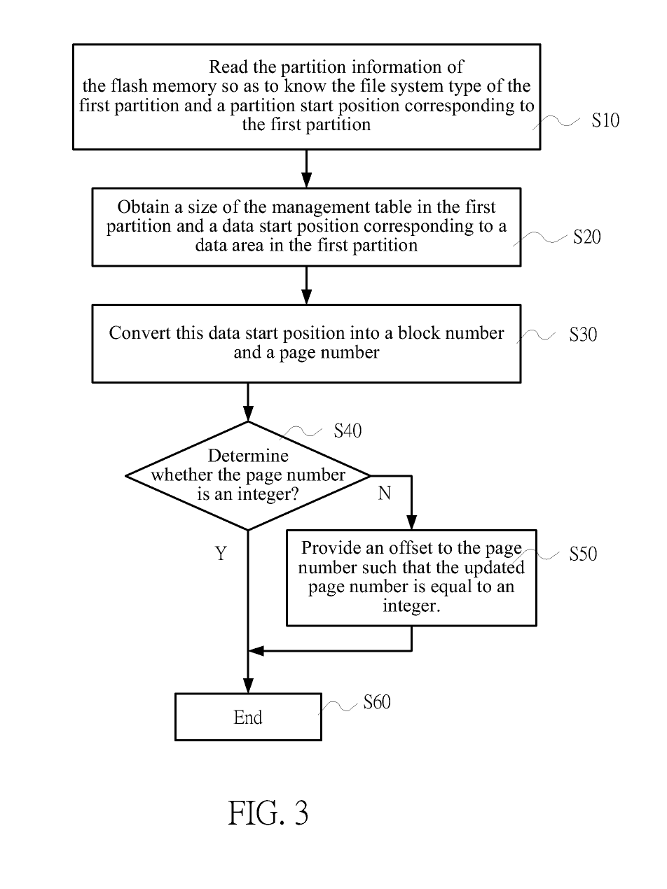

Please refer to FIG. 3. FIG. 3 is a flowchart illustrating a method of writing data into a flash memory based on file system according to an exemplary embodiment of the present invention. First, the FTL reads the partition information of the flash memory, so that the file system type of the first partition and a partition start position corresponding to the first partition can be known (S10). After that, a size of the management table in the first partition and a data start position corresponding to a data area in the first partition can be obtained (S20). Convert this data start position into a block number and a page number (S30). When the page number is equal to an integer (S40), ends the flowchart (S60); otherwise, when the page number is not equal to an integer (S40), provide an offset to the page number such that the updated page number is equal to an integer (S50).

As can be known from the abovementioned steps of the present invention, if the page number obtained from the conversion of the data start position is not equal to an integer, the FTL will add an offset to the page number such that the updated page number is equal to an integer. For example, the actual data start position in the first partition is expressed as (e1, e2+e3/8). When “e3” is not equal to 0, it means that the page number is a non-integer. Hence, a size of the offset should be (8-e3)/8 page, namely [(8-e3)*4K (bytes)/8].

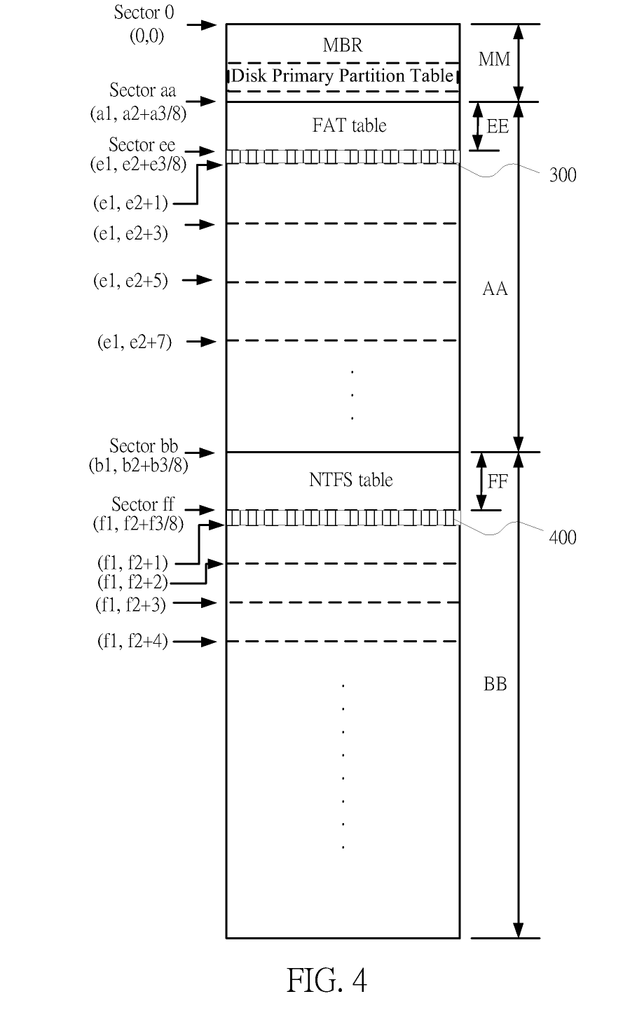

Please refer to FIG. 4. FIG. 4 is a diagram illustrating data areas and data sub-areas of a flash memory. Herein the page number corresponding to the actual data start position (e1, e2+e3/8) in the first partition is a non-integer. Hence, a size of a first offset 300 should be (8-e3)/8 page, namely [(8-e3)*4K(bytes)/8], and the updated page number should be (e2+1). In a similar way, the page number corresponding to the actual data start position (f1, f2+f3/8) in the second partition is a non-integer. Hence, a size of a second offset 400 should be (8-f3)/8 page, namely [(8-f3)*4K(bytes)/8], and the updated page number should be (f2+1).

Obviously, the first offset 300 and the second offset 400 provided by the FTL can make the data start positions in the first partition and the second partition be aligned with the pages in the flash memory. Additionally, owing to the sector units managed by FAT 32 of the first partition is 16K bytes (i.e., 32 sectors are equivalent to 2 pages), the data area in the first partition is divided into a plurality of data sub-areas in units of 16K bytes, wherein the data sub-areas are managed by the FAT table. Similarly, owing to the sector units managed by NTFS of the second partition is 4K bytes (i.e., 8 sectors are equivalent to 1 page), the data area in the second partition is divided into a plurality of data sub-areas in units of 4K bytes, wherein the data sub-areas are managed by the NTFS table.

From FIG. 4, we can see that when the data start position of each partition is aligned with one page, the data start positions corresponding to the data sub-areas in this partition are aligned with one page as well. As a result, the data start positions corresponding to the data sub-areas in the first partition are sequentially (e1, e2+1), (e1, e2+3), (e1, e2+5), (e1, e2+7) . . . and so on. Similarly, the data start positions corresponding to the data sub-areas in the second partition are sequentially (f1, f2+1), (f1, f 2+2), (f1, f2+3), (f1, f2+4) . . . and so on.

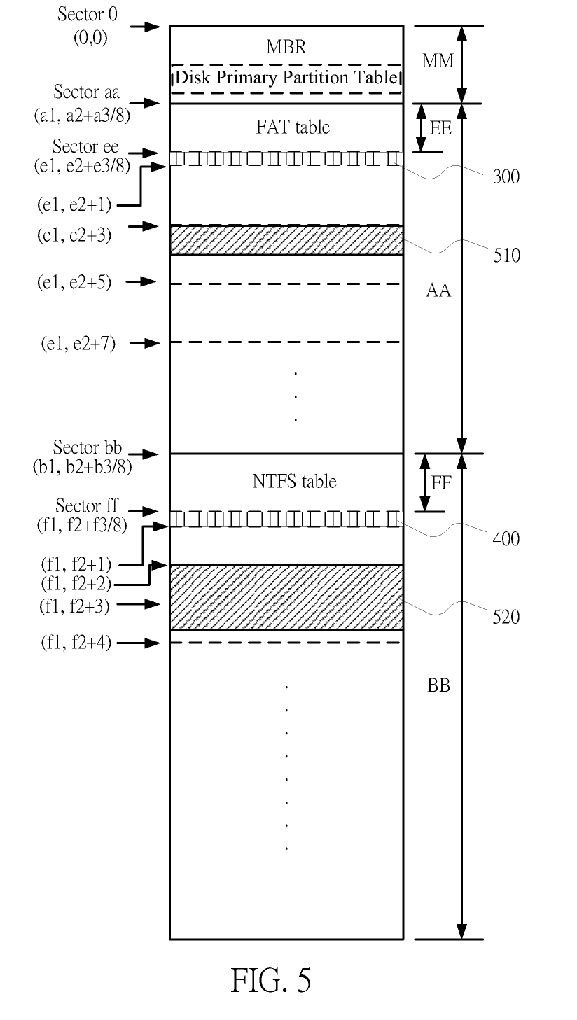

Please refer to FIG. 5. FIG. 5 is a diagram illustrating how a host writes data into the flash memory. According to an embodiment of the present invention, the writing commands issued by the host still use “sectors” as the basic unit. On the other hand, the writing commands received by the FTL need to convert the writing positions into block numbers and page numbers plus an offset, such that the writing positions must be aligned with one page. For this reason, the writing position must begin from the start position of one page. Assume that the host writes a first file 510 having a file size of 8K bytes into the first partition, and the writing position of the first file 510 begins from the data sub-areas of the “Sector (ee+32).” The FTL adds the first offset 300 to the “Sector (ee+32)” and then converts it into the position expressed by Page (e2+3) of Block e1, namely (e1, e2+3). Therefore, the writing position of the first file 510 begins from the position expressed by Page (e2+3) of Block e1, namely (e1, e2+3). After the writing of the first file 510 is completed, the remainder capacity of this data sub-area will no longer be able to write other data.

Similarly, when the host writes a second file 520 having a file size of 7K bytes into the second partition, and the writing position of the second file 520 begins from the data sub-areas of the “Sector (ff+8)”. The FTL adds the second offset 400 to the “Sector (ff+8)” and then converts it into the position expressed by Page (f2+2) of Block f1, namely (f1, f2+2). Therefore, the writing position of the second file 520 begins from the position expressed by Page (f2+2) of Block f1, namely (f1, f2+2). After the writing of the second file 520 is completed, the first data sub-area has no remainder capacity, while the next data sub-area has remainder capacity. Similarly, this remainder capacity included in the next data sub-area will not longer be able to write other data.

In summary, the present invention has the advantage of providing a method of writing data into a flash memory based on file system characteristics. When the data start position corresponding to a partition in the flash memory is not aligned with one page, the FTL adds an offset to this data start position, such that the writing positions of the flash memory are able to begin from the start position of one page. Therefore, the access performance of the flash memory can be effectively improved.

From what has been discussed above, we can draw the conclusion that the method of writing data into a flash memory based on file system characteristics disclosed in the present invention is able to solve the abovementioned problems in the prior art, such that the main purpose of the present invention can be achieved. While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method of writing data into a flash memory based on file system, comprising the following steps:
obtaining a data start position of a data area in a first partition of the flash memory;
converting the data start position into a first block number and a first page number;
when the first page number is not an integer, calculating an offset and adding the offset to the first page number to be an updated first page number; and
setting the first block number and the updated first page number as a new data start position of the data area, and writing a first data into the flash memory according to the new data start position.

2. The method of writing data into a flash memory based on file system of claim 1, wherein the flash memory comprises a thumb drive, a compact flash (CF) memory card, a secure digital (SD) memory card, or a multi media card (MMC).

3. The method of writing data into a flash memory based on file system of claim 1, wherein a partition start position of the first partition is recorded in a disk primary partition table of a master boot record (MBR) in the flash memory.

4. The method of writing data into a flash memory based on file system of claim 3, wherein the master boot record is used for recording a sector unit managed by the first partition, so that the data area is divided into a plurality of data sub-areas according to the new data start position and the sector unit.

5. The method of writing data into a flash memory based on file system of claim 3, wherein the first partition further comprises a management table, and the data start position is equal to the partition start position plus a size of the management table.

6. The method of writing data into a flash memory based on file system of claim 3, wherein the master boot record is used for recording a file system type of the first partition.

7. The method of writing data into a flash memory based on file system of claim 6, wherein the file system type comprises a file allocation table 12 file system (FAT 12), a file allocation table 16 file system (FAT 16), a file allocation table 32 file system (FAT 32), a new technology file system (NTFS), a second extended file system (EXT 2), or a third extended file system (EXT 3).
